(19) United States
(12) Patent Application Publication
(10) Pub. No.: US 2003/0210349 A1
(43) Pub. Date: Nov. 13, 2003

(54) Deinterlacing of mixed progressive and non-progressive sequences

(76) Inventors: Michael Evan Crabb, Carmel, IN (US); Donald Henry Willis, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/143,740

(22) Filed: May 10, 2002

(51) Int. Cl. H04N 7/01

(52) U.S. Cl. 348/448

(57) ABSTRACT

A method (500) of converting interlaced video to progressive video can include receiving a video signal (505) representative of at least one picture and determining whether the at least one picture is progressive (510). Responsive to the progressive picture determination, a vertical synchronization signal can be selectively modified to identify whether a field previously sent and a field to immediately follow are from a same progressive picture (615, 640).

### BACKGROUND OF THE INVENTION

1. Technical Field

This invention relates to the field of decoding Moving Picture Experts Group (MPEG) images, and more particularly, to a method and system for transferring information used in the decoding of an MPEG video sequence from the decoder hardware to an external device for use in converting interlaced video to progressive video.

2. Description of the Related Art

When a deinterlacer operates on a Moving Picture Experts Group (MPEG) decoded signal, it can achieve perfect deinterlacing of progressive pictures. This, however, is conditioned upon knowing which field begins a picture. To properly convert the interlaced video to progressive video, this information must be provided from the MPEG decoder to the deinterlacing unit.

In the past, the deinterlacer either did not use this information or was in the same integrated circuit as the MPEG decoder. In consequence, this information did not have to be provided to the deinterlacer. As products now include deinterlacers which are separately configured from the MPEG decoder, the deinterlacer must determine this information independently of the MPEG decoder or, the MPEG decoder must provide the information to the deinterlacer.

Presently, it is problematic for a deinterlacer to independently determine which field begins a picture. In illustration, one technique used by some deinterlacers is to analyze the video signal pixels to determine which field begins a picture. Such an analysis, however, is complicated and can be error prone.

Techniques for providing field information from the MPEG decoder to the deinterlacer have been proposed, but also have disadvantages. For example, one proposed solution involves altering the pulse width of a vertical synchronization pulse directly preceding a first field of a progressive picture. The pulse width of the vertical synchronization pulse is returned to a normal width for fields which are not the first field of a progressive picture.

This solution, however, also suffers from deficiencies. Specifically, ambiguities can arise when dealing with mixtures of progressive and non-progressive pictures, particularly in cases where the progressive pictures can be transmitted as more than two fields per picture. For example, film-based material in 3-2 pulldown format can be interspersed with non-progressive sequences. Here, the ambiguity arises due to the fact that there is no distinction between a third or more fields of a progressive picture and a field of a non-progressive picture. The deinterlacer requires this information to determine whether field merging or motion-adaptive processing should be used to deinterlace the picture. If the wrong deinterlacing mode is chosen, the result is either significant motion artifacts within the resulting picture or a low quality deinterlaced frame.

Thus, a need exists for a deinterlacer and method that overcomes the detriments described above.

### SUMMARY OF THE INVENTION

The invention disclosed herein provides a method, apparatus, and system for transferring information for use in converting interlaced video to progressive video. In particular, when progressive pictures are decoded in a Moving Picture Experts Group (MPEG) decoder, the vertical synchronization signal can be selectively pulse width modulated to indicate consecutive fields of pictures that can be merged and consecutive fields of pictures that cannot be merged.

One aspect of the present invention can include a method of converting interlaced video to progressive video. The method can include receiving a video signal representative of one or more pictures and determining whether the one or more pictures are progressive. Responsive to the progressive picture determination, a vertical synchronization signal can be selectively modified to identify that a field previously sent and a field to immediately follow are from a same progressive picture.

Another aspect of the present invention can include a system for converting interlaced video to progressive video. The system can include a decoder configured to convert a received MPEG video data stream to an interlaced video signal. The MPEG video data stream can specify progressive and non-progressive pictures. The decoder can selectively pulse width modulate a vertical synchronization signal to identify which ones of consecutive fields are from a same progressive picture. The system further can include a deinterlacer configured to convert the interlaced video signal to a progressive video signal based upon the selectively pulse width modulated vertical synchronization signal.

Another aspect of the present invention can include a decoder configured to convert a received MPEG video data stream to an interlaced video signal. The MPEG video data stream can specify progressive and non-progressive pictures. The decoder can be configured to selectively pulse width modulate a vertical synchronization signal to identify which ones of consecutive fields are from a same progressive picture.

Accordingly, the present invention relieves the deinterlacer from having to independently determine which field begins a picture. Additionally, the present invention can distinguish between a third or more fields of a progressive picture and a field of a non-progressive picture thereby eliminating ambiguities resulting in visual artifacts and substandard deinterlaced frames.

### BRIEF DESCRIPTION OF THE DRAWINGS

There are shown in the drawings embodiments which are presently preferred, it being understood, however, that the invention is not so limited to the precise arrangements and instrumentalities shown.

FIG. 1 is a block diagram illustrating an exemplary system for performing interlaced to progressive scan conversion.

FIG. 2 is a block diagram illustrating another exemplary system for performing interlaced to progressive scan conversion.

FIG. 3 is a schematic diagram illustrating the difference between a normal vertical synchronization signal and a modulated vertical synchronization signal in accordance with the present invention.

FIG. 4 is a schematic diagram illustrating the difference between a normal vertical synchronization signal and a modulated vertical synchronization signal in accordance another aspect of the present invention.

FIG. 5 is a flow chart illustrating an exemplary method for transferring information for use in converting interlaced video to progressive video. FIG. 6 is a flow chart illustrating another exemplary method for transferring information for use in converting interlaced video to progressive video.

### DETAILED DESCRIPTION

The invention disclosed herein provides a method and system for transferring information for use in converting interlaced video to progressive video. More specifically, the invention provides for the transference of information obtained in the decoding of a Moving Picture Experts Group (MPEG) video sequence from the decoder hardware to an external device for use in converting interlaced video to progressive video. The method can be implemented, for example, on a high definition television (HDTV) receiver having a liquid crystal on silicon (LCOS) imager.

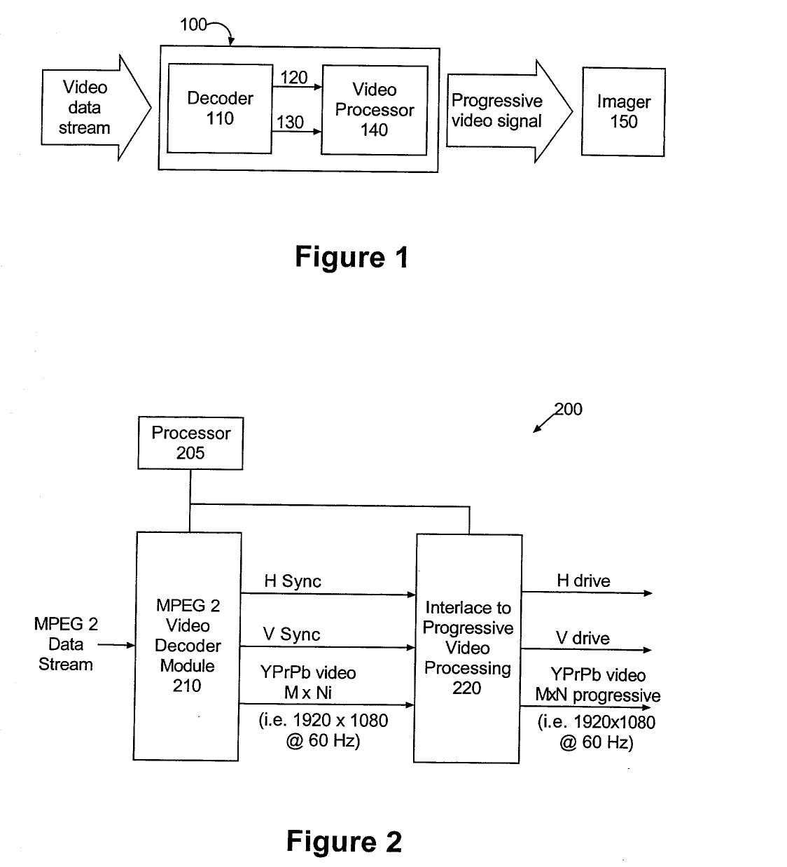

FIG. 1 is a block diagram illustrating an exemplary scan conversion system 100 for performing interlaced to progressive scan conversion in accordance with the inventive arrangements disclosed herein. As shown in FIG. 1, the scan conversion system 100 can include a decoder 110 operatively connected to a video processor 140. For example, the decoder 110 can be an MPEG 2 video decoder module and the video processor 140 can be an interlace to progressive video processor.

A video data stream can be provided to the scan conversion system 100. The decoder 110 can process the received data stream to output analog video component signals 130 and synchronization signals 120. The synchronization signals 120 can include horizontal and vertical synchronization signals. In particular, the vertical synchronization signal can be a pulse signal having a pulse duration of T. The vertical synchronization signal can be modified by the decoder 110 to indicate which fields are from the same progressive picture and can be merged, as well as which fields are not from the same progressive picture or are not progressive at all, and therefore, should not be merged. For example, the decoder 110 can modify the vertical synchronization signal to indicate the first field of a progressive picture, fields of a progressive picture which are not first fields, as well as fields of non-progressive pictures. The resulting signals 120 and 130 can be provided to the video processor 140 for conversion from an interlaced video signal to a progressive video signal. After conversion of the video signal, the resulting progressive video signal can be provided to an imager or display 150. Notably, the imager can be an LCOS imager for use with an HDTV receiver, however, the invention is not limited to such display technologies and is equally applicable an image display method capable displaying progressively scanned pictures.

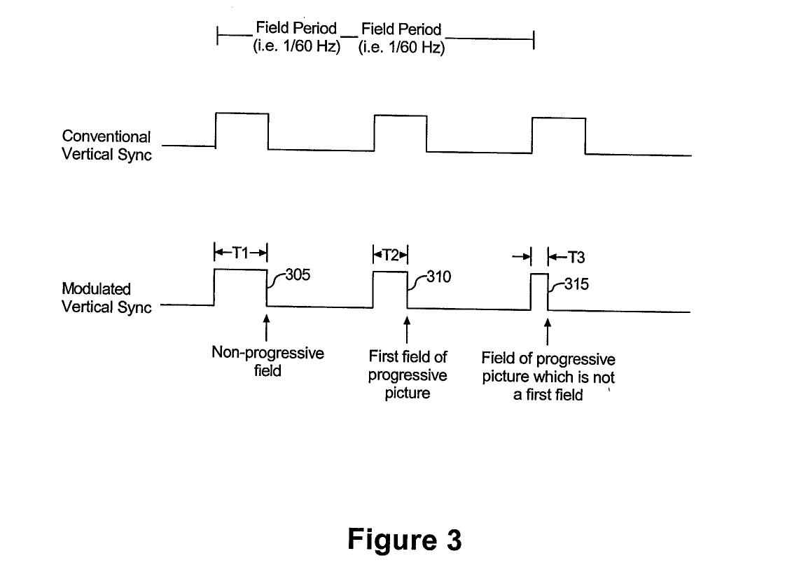

FIG. 2 is a block diagram illustrating another exemplary scan conversion system 200 for performing interlaced to progressive scan conversion. As shown in FIG. 2, the scan conversion system 200 can include an MPEG 2 video decoder module (MPEG decoder) 210, an interlace to progressive video processing system (deinterlacer) 220, and a processor 205. The MPEG decoder 210 can convert an MPEG 2 data stream to a video signal. The deinterlacer 220 can receive an interlaced video signal having mixed progressive and non-progressive sequences and convert that signal to a progressive video signal. The processor 205 can coordinate the actions of the MPEG decoder 210 and the deinterlacer 220. Each of the aforementioned components can be communicatively linked through an appropriate data connection, for example a data communications bus or other connection circuitry.

As shown in FIG. 2, an MPEG 2 data stream can be received by the decoder 210. The MPEG decoder 210 can process the received data stream to produce an output. The output of the MPEG decoder 210 includes analog component video signals plus two other signals, specifically horizontal synchronization (H sync) and vertical synchronization (V sync) signals, transmitted as an interlaced signal. The three component video signals can be converted to digital signals and sent, along with the two synchronization signals, to the deinterlacer 220.

The MPEG decoder 210 can parse the picture header bits of pictures specified by the data stream to determine whether the picture is progressive or non-progressive. If a picture is determined to be a progressive picture, the header bits further can be parsed to determine a first field of the progressive picture. The MPEG decoder 210 can selectively pulse width modulate the vertical synchronization signal to indicate one of several different conditions. The MPEG decoder 210 operates under the control of the processor 205. The MPEG decoder 210 also is capable of changing the vertical synchronization pulse width on every synchronization pulse, if necessary.

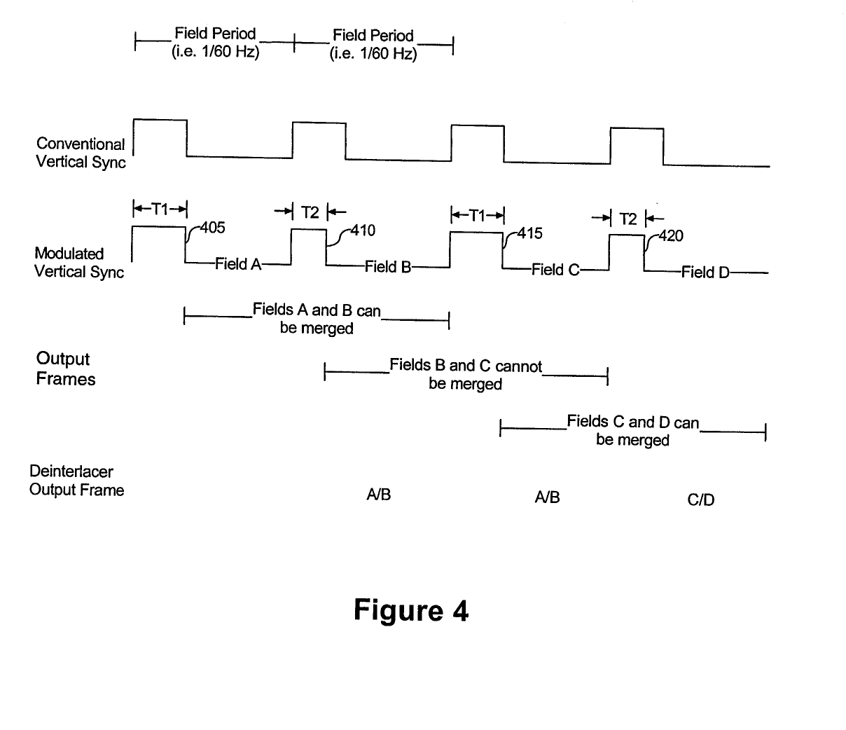

In one embodiment, shown in FIG. 3, the vertical synchronization signal can be selectively pulse width modulated to indicate one of three possible conditions. Specifically, the duration T of a vertical synchronization pulse can be increased or decreased to indicate that the field to follow is a first field of a progressive picture, a field of a progressive picture which is not a first field, or a field of a non-progressive picture. For example, unique pulse widths of T1, T2, and T3 can be associated with each of the aforementioned conditions. Accordingly, a pulse having a width of T(n) directly preceding a field indicates to the deinterlacer 220 which of the three field types will be forthcoming.

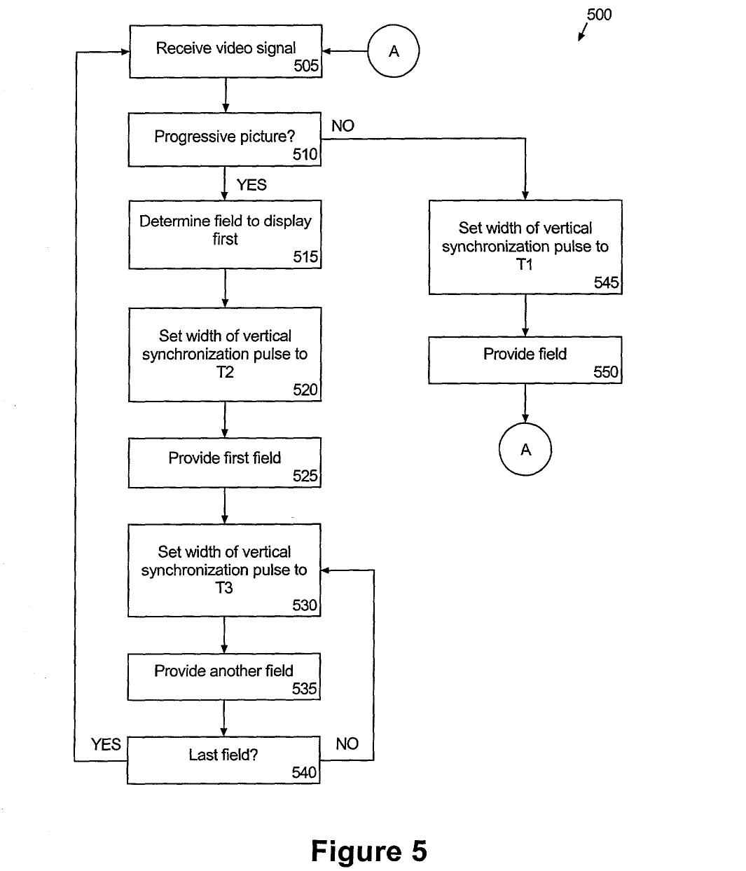

In another aspect of the present invention, shown in FIG. 4, the vertical synchronization signal can be selectively pulse width modulated to indicate one of two different conditions. The first condition being that the field immediately preceding and the field immediately following the vertical synchronization pulse are from a same progressive picture, and thus, can be merged. The second condition being that the pulse immediately preceding and immediately following the vertical synchronization pulse are not from the same progressive picture or are not progressive at all, and thus, should not be merged.

Those skilled in the art will recognize that the pulse widths can be increased or decreased depending upon the particular embodiment of the invention, so long as a unique pulse width is associated with each of the conditions described herein. However, it will be appreciated that the leading edge of the vertical synchronization pulse must remain inviolate to preserve timing of vertical synchronization.

FIG. 3 illustrates the difference between a normal vertical synchronization signal, depicted as positive pulses, and a modulated vertical synchronization signal in accordance with the inventive arrangements. As shown in FIG. 3, the modulated vertical synchronization signal can include pulses of three different widths T1, T2, and T3. Accordingly, pulse 305 having a width of T1 can indicate that the field immediately following is a field of a non-progressive picture. Pulse 310 having a width of T2 can indicate that the pulse immediately following is a first field of a progressive picture. Pulse 315 having a width of T3 can indicate that that the field immediately following is field of a progressive picture which is not the first field.

FIG. 4 also illustrates the difference between a normal vertical synchronization signal shown with positive pulses, and a modulated vertical synchronization signal in accordance with another aspect of the inventive arrangements disclosed herein. As shown in FIG. 4, the modulated vertical synchronization signal includes two pulses having widths of T1 and T2. Pulses 405 and 415, each having a width of T1, can indicate that the field immediately preceding and the field immediately following these pulses should not be merged. For example, the fields may not be from the same picture or may not be progressive. Pulses 410 and 420, each having a width of T2, can indicate that the field immediately preceding and the field immediately following these pulses can be merged. Such is the case, for example, when the fields are from the same progressive picture.

Thus, as shown in FIG. 4, pulse 410 indicates that fields A and B can be merged. Pulse 415 indicates that fields B and C cannot be merged. Pulse 420 indicates that fields C and D can be merged. Accordingly, as shown in the “Output Frames” line of FIG. 4, the modulated vertical synchronization signal indicates that field A can be perfectly deinterlaced by merging field A with field B. Likewise, the vertical synchronization signal indicates that field C can be perfectly deinterlaced with field D. In this embodiment, the deinterlacer need only recall two field periods to implement the proper deinterlacing mode.

The inventive arrangements contemplate not only the generation and use of the modified vertical synchronization signal as shown, but also the capacity to change between the normal vertical synchronization signal and the modified vertical synchronization signal, preferably automatically, as necessary. The inventive arrangements disclosed herein further allow a suitably configured deinterlacer to determine whether field merging or motion-adaptive processing should be used.

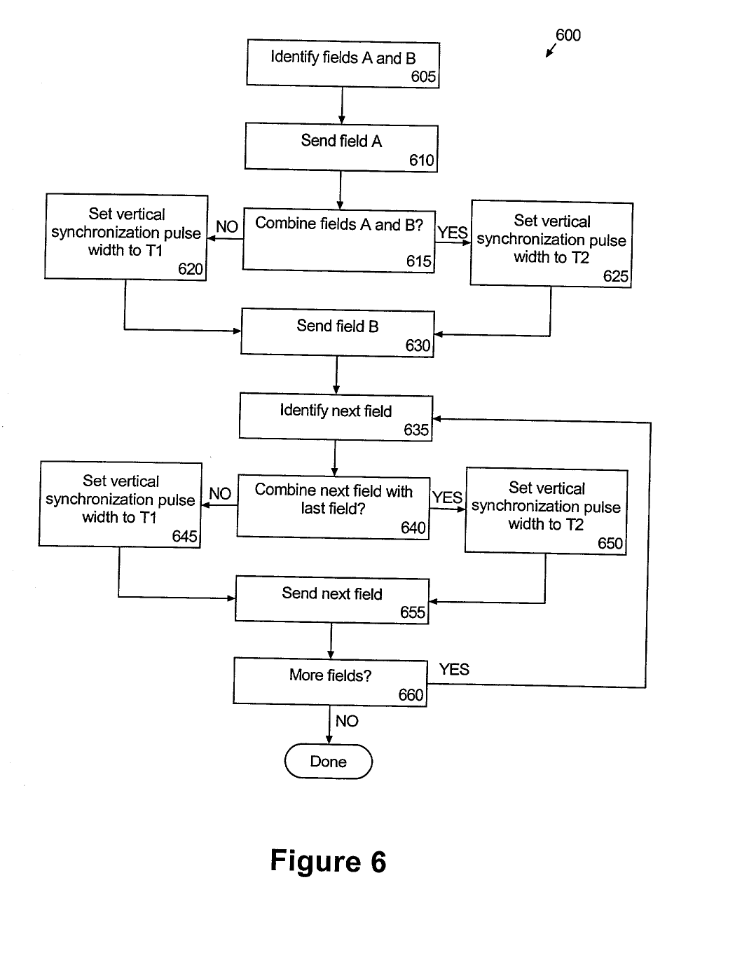

FIG. 5 is a flow chart 500 illustrating an exemplary method for transferring information for use in converting interlaced video to progressive video. The method 500 can begin in step 505 where a video signal containing a picture can be received. In step 510, the received video signal can be analyzed to determine whether the picture contained therein is a progressive picture. An analysis of the pixels of the picture can reveal such information. With regard to an MPEG data stream, the determination can be made by parsing MPEG header information. If the picture is non-progressive, the method can branch to step 545 where the width of the vertical synchronization pulse can be set to T1 indicating that the field to follow is non-progressive. The timing of the leading edge of the pulse can be preserved. Accordingly, in step 550, the non-progressive field can be provided. After step 550, the method can continue to step 505 and repeat as necessary to process further video signals.

If in step 510, the received picture was determined to be progressive, the method can continue to step 515. In step 515, a determination can be made as to which field of the received frame is to be displayed first. If an MPEG video data stream has been received, again, this determination can be made by parsing the MPEG header information. In step 520, the pulse width of the vertical synchronization signal can be set to T2 thereby indicating that a first field of a progressive picture is to immediately follow. The timing of the leading edge of the pulse can be preserved. Thus, in step 525, the first field of the received frame can be provided, for example, to an interlace to progressive video processor.

In step 530, the pulse width of the vertical synchronization signal can be set to T3 indicating that a field of a progressive picture which is not a first field will be forthcoming. As mentioned, the timing of the leading edge of the pulse can be preserved. In step 535, the second or next field of the frame can be provided. After completion of step 535, the method can continue to step 540.

In step 540, a determination can be made as to whether the field just provided in step 535 was the last field of the picture. If so, the method can continue to step 505 and repeat as necessary to process further video signals. If the field was not the last field of the picture, the method can continue to step 530 where the pulse width of the vertical synchronization signal can remain set to T3 and another field of the frame can be provided. The method can repeat steps 530, 535, and 540 as necessary until each field of the frame has been provided.

FIG. 6 is a flow chart 600 illustrating another exemplary method for transferring information for use in converting interlaced video to progressive video. The method 600 can begin in a state wherein video signals containing pictures are being received for processing. Accordingly, in step 605, the first two fields to be sent, for example to an output device such as an HDTV receiver, can be identified as fields A and B. In step 610, field A can be sent. In step 615, a determination can be made as to whether the two fields A and B are to be merged. For example, a determination can be made as to whether fields A and B are from the same progressive picture. If fields A and B are to be merged, the method can continue to step 625 where the pulse width of the vertical synchronization signal can be set to T2. The pulse width T2 can indicate that the forthcoming field B is to be merged with the previously sent field A. If the fields are not to be merged, for example in the case where the fields are not from the same progressive picture or are not progressive at all, the method can continue to step 620. In step 620, the pulse width of the vertical synchronization signal can be set to T1 indicating that the forthcoming field B is not to be merged with field A.

After setting the width of the vertical synchronization signal, field B can be sent in step 630. In step 635, the next field to be sent can be identified. In step 640, a determination can be made as to whether the next field is to be merged with the last field sent, in this case field B. If so, the method can continue to step 650 where the pulse width of the vertical synchronization signal can be set to T2 indicating that the next field to be sent can be merged with field B. If not, however, the method can continue to step 645 where the pulse width of the vertical synchronization signal can be set to T1 indicating that the next field cannot be merged with field B. After setting the pulse width of the vertical synchronization signal, the method can continue to step 655 where the next field can be provided.

In step 660, a determination can be made as to whether any additional fields remain to be sent. If so, the method can continue to step 635 to identify the next field and repeat as necessary to process the video signal. If not, the method can end.

According to one aspect of the present invention, resulting progressive video signals can be provided to an output device. For example, the resulting progressive video signal can be provided to an HDTV monitor or receiver having, for example an LCOS display, or a direct or projection cathode ray tube display. Still, the invention disclosed herein can be embodied in other specific forms without departing from the spirit or essential attributes thereof. Accordingly, reference should be made to the following claims, rather than to the foregoing specification, as indicating the scope of the invention.

What is claimed is:

1. A method of converting interlaced video to progressive video, said method comprising:
receiving a video signal representative of at least one picture;
determining whether said at least one picture is progressive; and
responsive to said progressive picture determination, selectively modifying a vertical synchronization signal to identify whether a field previously sent and a field to immediately follow are from a same progressive picture.

2. The method of claim 1, further comprising:
selectively modifying a vertical synchronization signal to identify whether a field previously sent and a field to immediately follow are not from a same progressive picture.

3. The method of claim 1, further comprising:
determining first fields of said progressive pictures.

4. The method of claim 3, said selectively modifying step further comprising:
modifying said vertical synchronization signal to identify a first field of a progressive picture, a field of a progressive picture which is not a first field, or a field of a non-progressive picture.

5. The method of claim 1, further comprising:
converting said video signal to an interlaced video signal having said modified vertical synchronization signal.

6. The method of claim 5, further comprising:
converting said interlaced video signal having said modified vertical synchronization signal to a progressive video signal by applying field merging processing or motion-adaptive processing according to said modified vertical synchronization signal.

7. The method of claim 6, further comprising:
providing said progressive video signal to a liquid crystal on silicon imager.

8. The method of claim 6, further comprising:
providing said progressive video signal to a high definition television receiver having a liquid crystal on silicon imager.

9. The method of claim 2, wherein said vertical synchronization signal is a pulse signal and said step of modifying said vertical synchronization signal comprises selectively pulse width modulating said vertical synchronization signal to include at least one of two pulses having unique pulse widths.

10. The method of claim 4, wherein said vertical synchronization signal is a pulse signal and said step of modifying said vertical synchronization signal comprises selectively pulse width modulating said vertical synchronization signal to include at least one of three pulses having unique pulse widths.

11. The method of claim 1, said receiving step comprising:
receiving a video data stream representative of said video signal.

12. The method of claim 11, said determining step comprising:
parsing header information in said received video data stream.

13. The method of claim 11, said receiving step comprising:
receiving a Moving Picture Experts Group (MPEG) video data stream.

14. A system for converting interlaced video to progressive video, said system comprising:
a decoder for decoding an Moving Picture Experts Group (MPEG) video data stream to form an interlaced video signal, said MPEG video data stream specifying progressive and non-progressive pictures, wherein said decoder selectively pulse width modulates a vertical synchronization signal to identify which ones of consecutive fields are from a same progressive picture; and
a deinterlacer coupled to said decoder, and converting said interlaced video signal to a progressive video signal in accordance with said selectively pulse width modulated vertical synchronization signal.

15. The system of claim 14, wherein said decoder is configured to identify first fields of progressive pictures, fields of progressive pictures which are not first fields, and fields of non-progressive pictures.

16. The system of claim 14, wherein said decoder is configured to identify whether a field previously sent and a field to immediately follow are from a same progressive picture.

17. The system of claim 16, wherein said decoder is configured to identify whether a field previously sent and a field to immediately follow are not from a same progressive picture.

18. The system of claim 14, further comprising:
a liquid crystal on silicon imager for displaying said progressive video signal.

19. The system of claim 14, further comprising:
a video display having a liquid crystal on silicon imager for displaying said progressive video signal.

21. A decoder configured to convert an MPEG video data stream to an interlaced video signal, said MPEG video data stream specifying progressive and non-progressive pictures, wherein said decoder selectively modulates a width of a pulse forming a vertical synchronization signal to identify which ones of consecutive fields are from a same progressive picture.

22. The decoder of claim 21, further configured to identify first fields of progressive pictures, fields of progressive pictures which are not first fields, and fields of non-progressive pictures.

23. The decoder of claim 21, further configured to identify whether a field previously sent and a field to immediately follow are from a same progressive picture.

24. The decoder of claim 23, further configured to identify whether a field previously sent and a field to immediately follow are not from a same progressive picture.
